(19) United States
(12) Patent Application Publication
(10) Pub. No.: US 2023/0125708 A1
(43) Pub. Date: Apr. 27, 2023

(54) ADAPTER DEVICE AND CONNECTING MECHANISM THEREOF

(71) Applicant: WONDERLAND SWITZERLAND AG, Steinhausen (CH)

(72) Inventor: Yange HU, Dongguan, Guangdong (CN)

(21) Appl. No.: 17/912,376

(22) PCT Filed: Mar. 12, 2021
(86) PCT No.: PCT/EP2021/056389

§ 371 Date: Sep. 16, 2022

(30) Foreign Application Priority Data
Mar. 16, 2020 (CN) 202010182921.X

(51) Int. Cl. F16B 21/09; B62B 9/12

(52) U.S. Cl. CPC F16B 21/09; B62B 9/12; B62B 2205/20

(57) ABSTRACT

A connecting mechanism includes a first joint, a second joint, a lock pin, an unlock operating member and a stationary base. The first joint is pivotally connected to the second joint. The lock pin is movably disposed between the first joint and the second joint and configured to lock or unlock the first joint and the second joint. The unlock operating member is connected to the lock pin and configured to drive the lock pin to disengage from the first joint or/and the second joint, so as to unlock the first joint and the second joint. The stationary base is connected to the first joint or the second joint and configured to be detachably connected to a baby carriage.

### RELATED APPLICATIONS

The present application is a U.S. National Phase of International Application Number PCT/EP2021/056389, filed Mar. 12, 2021, which claims priority to Chinese Application No. 202010182921.X, filed Mar. 16, 2020.

### FIELD

One or more embodiments according to the present invention relate to a baby carriage, particularly an adapter device and a connecting mechanism thereof adapted to a baby carriage.

### BACKGROUND

Various types of baby carriages (e.g., stroller, safety seat, bassinet, crib, etc.) have been widely used in families with babies. For example, a bassinet is mainly suitable for babies from birth until about 15 months old. The bassinet can be installed on a base of a car seat to avoid or reduce the vibration or bumps caused by braking or collision between vehicles, so as to protect the baby. The bassinet can be carried while walking after getting out of the car or when going out, such that it is convenient to carry the baby. The bassinet can also be used alone at home to increase the convenience of using the bassinet.

In order to reduce the burden of caregivers when going out, a bassinet has been developed to be used with a special stroller, so as to facilitate carrying the baby out. This kind of bassinet can only be used with a special stroller and cannot be used with other baby carriages, such that the use of the bassinet has limitations and is still not convenient enough.

Therefore, it is necessary to provide an adapter device to enable a bassinet to be used with various baby carriages and reduce needed storage space.

### SUMMARY

As will be seen more clearly from the detailed description following below, the claimed connecting mechanism includes a first joint, a second joint, a lock pin, an unlock operating member and a stationary base. The second joint is pivotally connected to the first joint. The lock pin is movably disposed between the first joint and the second joint and configured to lock or unlock the first joint and the second joint. The unlock operating member is connected to the lock pin and configured to drive the lock pin to disengage from the first joint or/and the second joint, so as to unlock the first joint and the second joint. The stationary base is connected to the first joint or the second joint and configured to be detachably connected to a baby carriage.

Preferably, the connecting mechanism further includes a linking member connected to the first joint and the second joint. When one of the first joint and the second joint receives force, the other one of the first joint and the second joint is driven to pivot by the linking member.

As will be seen more clearly from the detailed description following below, the claimed adapter device includes a first support member, a second support member and the aforesaid connecting mechanism. The first support member is connected to one of the first joint and the second joint. The second support member is connected to the other one of the first joint and the second joint.

### BRIEF DESCRIPTION OF THE DRAWINGS

In the following, the invention is further illustrated by way of example, taking reference to the accompanying drawings thereof:

FIG. 1 is a schematic view illustrating an adapter device being unfolded according to a first embodiment of the invention,

FIG. 2 is a schematic view illustrating the adapter device shown in FIG. 1 being folded,

FIG. 3 is a side view of FIG. 1,

FIG. 4 is a side view of FIG. 2,

FIG. 5 is an exploded view illustrating a connecting mechanism shown in FIG. 1,

FIG. 6 is an exploded view of FIG. 5,

FIG. 7 is a schematic view illustrating the structure shown in FIG. 6 from another viewing angle,

FIG. 8 is a schematic view illustrating a stationary base and a second joint shown in FIG. 6 from another viewing angle,

FIG. 9 is a schematic view illustrating a first joint shown in FIG. 7 from another viewing angle,

FIG. 10 is a schematic view of FIG. 8 without the second joint,

FIG. 11 is a schematic view of FIG. 8 without the stationary base,

FIG. 12 is a sectional view illustrating the connecting mechanism shown in FIG. 3,

FIG. 13 is a schematic view illustrating a folding process of FIG. 12,

FIG. 14 is a sectional view illustrating the connecting mechanism shown in FIG. 4,

FIG. 15 is a schematic view illustrating the connecting mechanism shown in FIG. 2 without the first joint,

FIG. 16 is another sectional view illustrating the connecting mechanism shown in FIG. 3,

FIG. 17 is another schematic view of FIG. 16,

FIG. 18 is a schematic view illustrating an adapter device being unfolded according to a second embodiment of the invention,

FIG. 19 is a schematic view illustrating the structure shown in FIG. 18 from another viewing angle,

FIG. 20 is an enlarged view illustrating a connecting mechanism shown in FIG. 18,

FIG. 21 is a schematic view illustrating a connecting mechanism shown in FIG. 18 without a stationary base,

FIG. 22 is a sectional view illustrating a connecting mechanism shown in FIG. 18,

FIG. 23 is a schematic view illustrating an adapter device being unfolded according to a third embodiment of the invention,

FIG. 24 is an exploded view illustrating a connecting mechanism shown in FIG. 23,

FIG. 25 is an exploded view of FIG. 24,

FIG. 26 is a schematic view illustrating a folding principle of the connecting mechanism shown in FIG. 23,

FIG. 27 is a schematic view illustrating another state of FIG. 26,

FIG. 28 is a side view illustrating the adapter device shown in FIG. 23, and

FIG. 29 is a side view illustrating the adapter device shown in FIG. 28 being folded.

### DETAILED DESCRIPTION

The embodiments of the invention will now be described with reference to the accompanying drawings, wherein similar numbers in the drawings represent similar elements.

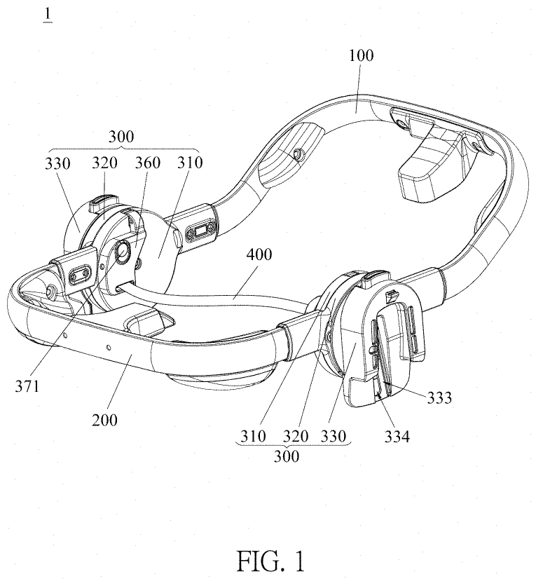

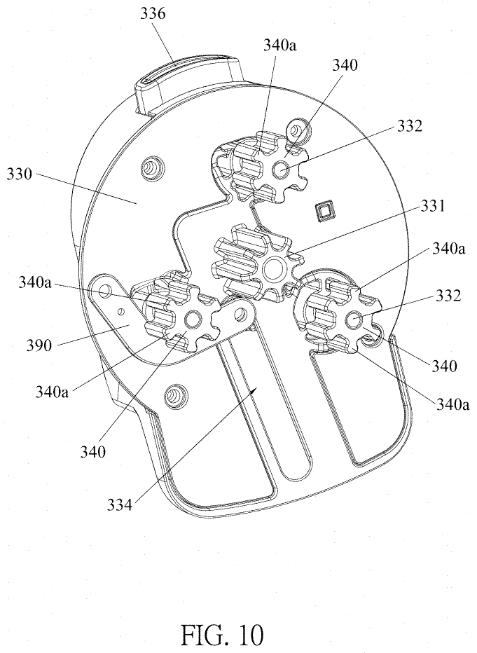

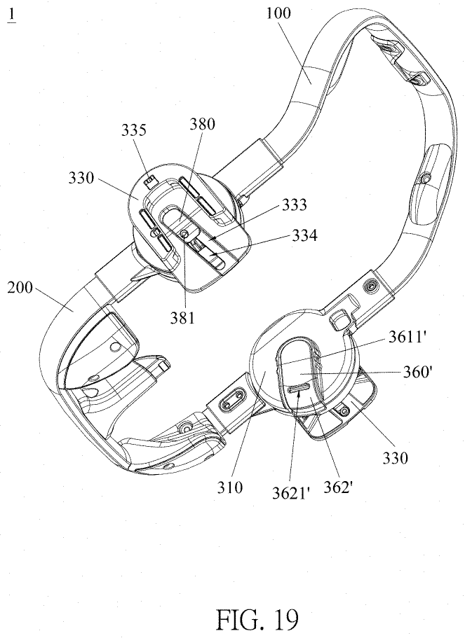

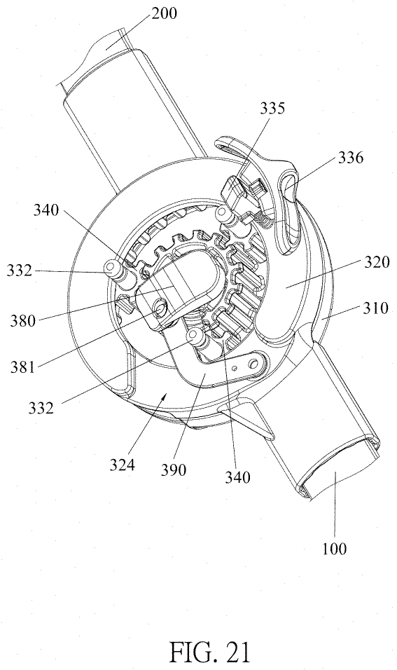

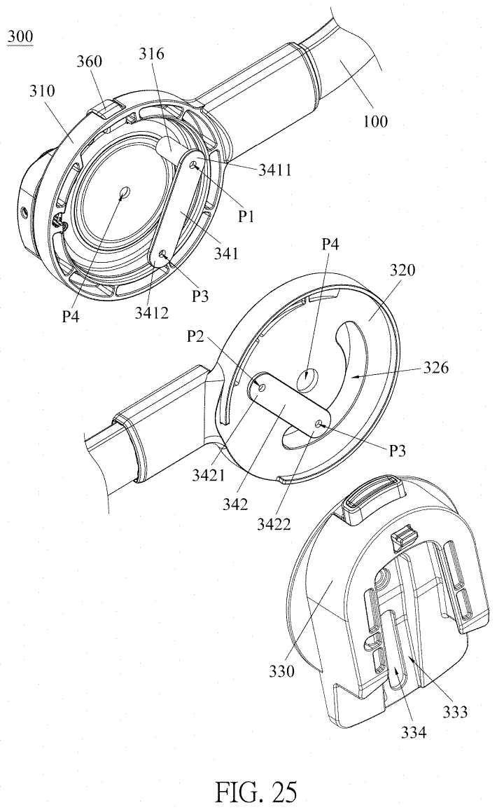

As shown in FIGS. 1 to 29, an adapter device 1 of an embodiment of the invention is mainly used to connect a baby containing device or install the baby containing device on different baby carriages, such that the baby containing device can be used more flexibly, wherein the baby containing device may be a bassinet, a safety seat, and so on and the baby carriage may be a stroller, a crib, a baby changing table, a safety seat base, and so on. It should be noted that the baby containing device and the baby carriage are not limited to those products mentioned in the above and both may be other baby products.

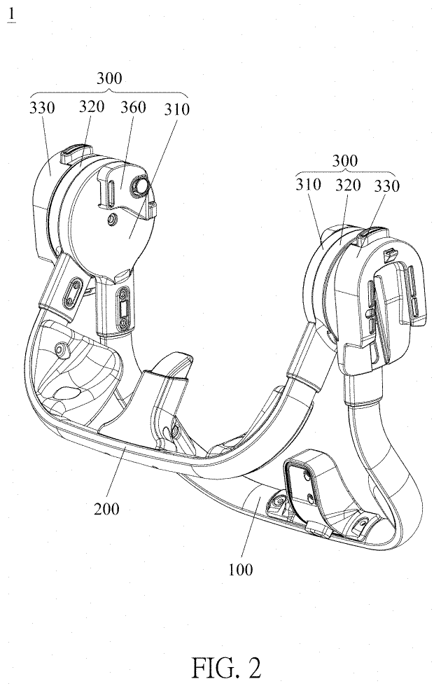

As shown in FIGS. 1 to 4, 18, 19 and 23, the adapter device 1 of an embodiment of the invention includes a first support member 100, a second support member 200, and a connecting mechanism 300 for connecting the first support member 100 and the second support member 200. The first support member 100 and the second support member 200 are substantially U-shaped. The first support member 100 and the second support member 200 are connected to each other by two connecting mechanisms 300. The adapter device 1 can be folded and unfolded by the two connecting mechanisms 300. Furthermore, the two connecting mechanisms 300 can be detachably connected to a baby carriage, so as to selectively install a baby containing device on different baby carriages according to different requirements. When the adapter device 1 is not in use, the adapter device 1 can be pivoted and folded (as shown in FIGS. 2, 4 and 29).

Referring to FIGS. 1 to 23, different embodiments of the adapter device 1 of the invention are described in the following.

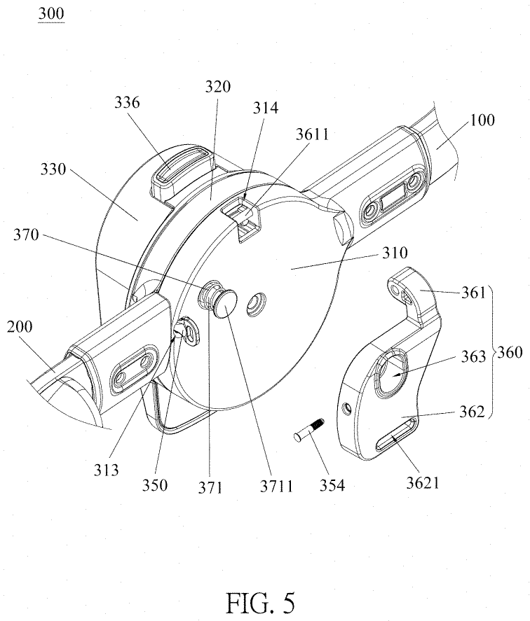

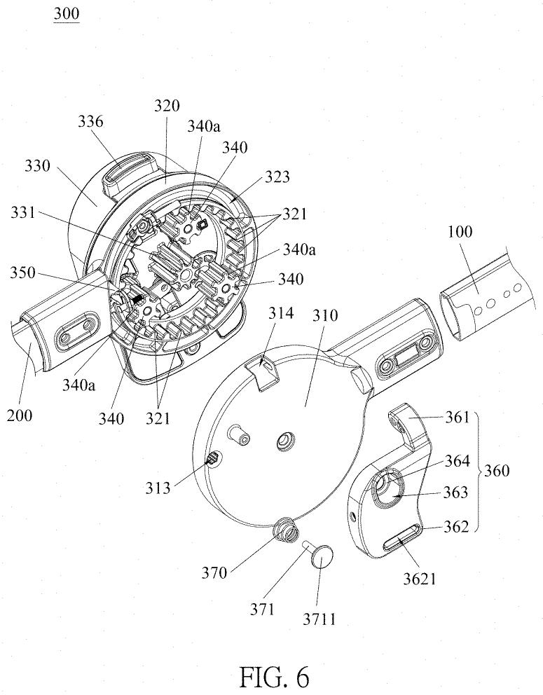

As shown in FIGS. 1 to 7, in a first embodiment of the adapter device 1 of the invention, two connecting mechanisms 300 have identical structures and are arranged symmetrically. One connecting mechanism 300 is exemplified in the following for illustration purpose. Specifically, the connecting mechanism 300 includes a first joint 310, a second joint 320, a stationary base 330, a linking member 340 (best seen in FIG. 6), a lock pin 350 (best seen in FIG. 5), an unlock operating member 360 and a return member 370 (best seen in FIG. 5). The second joint 320 is pivotally connected to the first joint 310. The first support member 100 is connected to one of the first joint 310 or the second joint 320. The second support member 200 is connected to the other one of the first joint 310 or the second joint 320. The lock pin 350 is movably disposed between the first joint 310 and the second joint 320 and configured to lock or unlock the first joint 310 and the second joint 320 with respect to each other. The unlock operating member 360 is connected to the lock pin 350 and configured to drive the lock pin 350 to disengage from the first joint 310 or/and the second joint 320, so as to unlock the first joint 310 and the second joint 320. The return member 370 abuts against the unlock operating member 360 and has a tendency to return the unlock operating member 360 to an initial position. Furthermore, the linking member 340 is disposed between the first joint 310 and the second joint 320. When one of the first joint 310 and the second joint 320 receives force, the other one of the first joint 310 and the second joint 320 is driven to pivot by the linking member 340, such that the adapter device 1 can be folded more conveniently and easily. The stationary base 330 is connected to the first joint 310 or the second joint 320 and configured to be detachably connected to a baby carriage.

In this embodiment, the first joint 310 is fixed to the first support member 100, the second joint 320 is fixed to the second support member 200, and a connecting shaft 331 is protruded from and configured on the stationary base 330. The connecting shaft 331 passes through the second joint 320 and is pivotally connected to the first joint 310, such that the second joint 320 is sandwiched in between the stationary base 330 and the first joint 310. The unlock operating member 360 is pivotally connected to the first joint 310 and connected to the lock pin 350. When force is applied on the unlock operating member 360 to rotate, the lock pin 350 is driven to move and unlock. Understandably, the installation positions of the first joint 310 and the second joint 320 can be reversed.

As shown in FIG. 1, the adapter device 1 further includes a pulling member 400. The unlock operating members 360 of the two connecting mechanisms 300 are connected to each other by the pulling member 400. Accordingly, the pulling member 400 can be pulled to simultaneously drive the two connecting mechanisms 300 to unlock, such that the operation for folding the adapter device 1 is more convenient. The pulling member 400 may be a webbing, a steel rope, a plastic strip or other ropes, but the invention is not so limited.

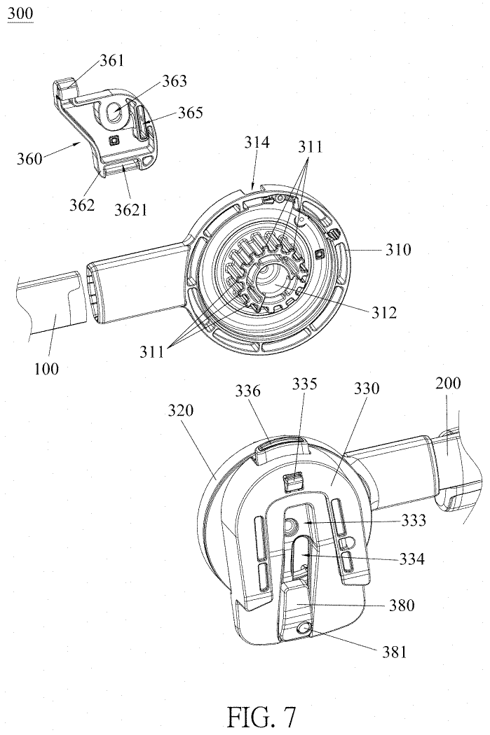

As shown in FIGS. 6 to 11, in this embodiment, the linking member 340 may be a gear pivotally connected between the first joint 310 and the second joint 320. The outside of the linking member 340 has a plurality of protruding teeth 340a. The first joint 310 has a plurality of first gear teeth 311 (best seen in FIG. 7) meshing with the protruding teeth 340a of the linking member 340. The second joint 320 has a plurality of second gear teeth 321 meshing with the protruding teeth 340a of the linking member 340. Accordingly, when one of the first joint 310 or the second joint 320 receives force, the first joint 310 and the second joint 320 pivot with respect to each other by an interaction among the first gear teeth 311, the protruding teeth 340a and the second gear teeth 321. Needless to say, the linking member 340 is not limited to gear and other components may be used to connect the first joint 310 and the second joint 320.

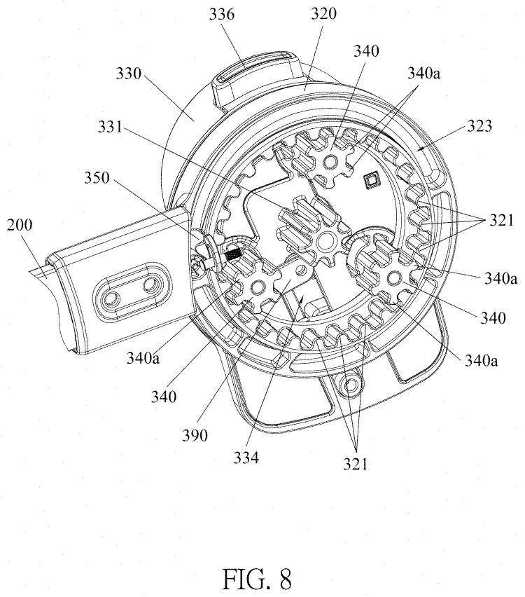

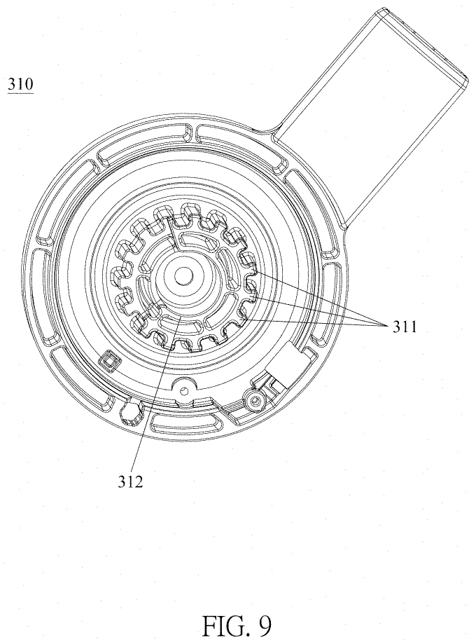

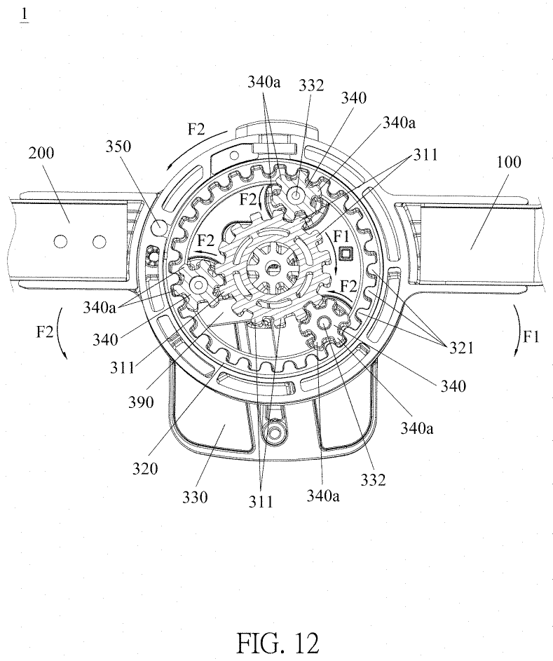

As shown in FIGS. 6 to 12, a connecting base 312 is protruded from and disposed at one side of the first joint 310 (as shown in FIGS. 7 and 9), wherein an inner diameter of the connecting base 312 corresponds to an outer diameter of the connecting shaft 331. The first joint 310 is pivotally connected to the connecting shaft 331 through the connecting base 312. The first gear teeth 311 are disposed at an outer wall of the connecting base 312 (as shown in FIGS. 7 and 9). The second joint 320 is circular and the second gear teeth 321 are disposed at an inner wall of the second joint 320 (as shown in FIGS. 6, 8 and 11). When the second joint 320 is pivotally connected to the first joint 310, the first gear teeth 311 and the second gear teeth 321 are separated from each other along a radial direction of the two joints (as shown in FIG. 12). Furthermore, a connecting pillar 332 is protruded from and configured on the stationary base 330. The linking member 340 is pivotally connected to the connecting pillar 332 and meshes with the second gear teeth 321. The linking member 340 protrudes from the second joint 320 along an axial direction of the connecting pillar 332 (as shown in FIG. 8), such that the linking member 340 is able to extend into the first joint 310 and meshes with the first gear teeth 311.

In accordance with at least one embodiment, the connecting mechanism 300 may include a plurality of linking members 340 evenly arranged around the connecting shaft 331, wherein the connecting shaft 331 is a pivot axis of the first joint 310 and the second joint 320. In this embodiment, there are three linking members 340 parallel to the connecting shaft 331 and evenly arranged on the stationary base 330. Needless to say, the number of linking members 340 is not limited to three.

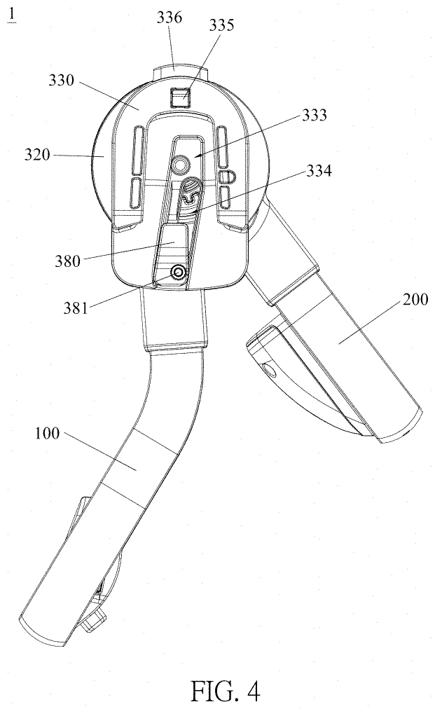

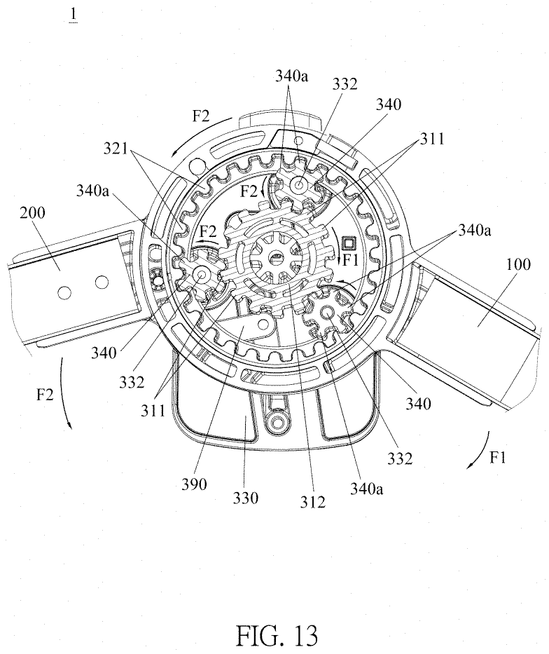

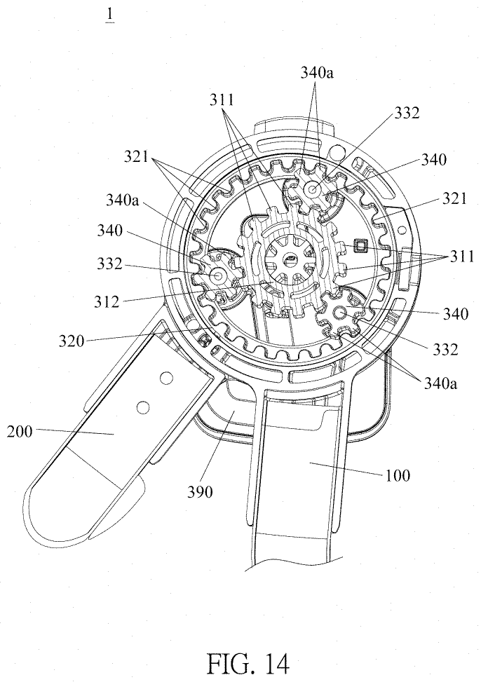

As shown in FIGS. 12 to 14, FIG. 12 is a sectional view illustrating the connecting mechanism 300 when the adapter device 1 is unfolded. When the connecting mechanism 300 is unlocked and the first support member 100 rotates along a direction indicated by an arrow F1 in FIG. 12, the first support member 100 drives the first joint 310 to rotate synchronously. At this time, the first gear teeth 311 of the first joint 310 act on the protruding teeth 340a to drive the linking member 340 to rotate reversely, i.e., the linking member 340 rotates along a direction indicated by an arrow F2 in FIG. 12, so as to act on the second gear teeth 321 to drive the second joint 320 to rotate along the direction indicated by the arrow F2 in FIG. 12, i.e., a rotating direction of the second joint 320 is opposite to a rotating direction of the first joint 310. Thus, only a single hand is needed to push the first support member 100 to pivot, and the second support member 200 is driven to rotate reversely towards the first support member 100 (as shown in FIG. 13). Accordingly, the folding operation is simpler and more labor-saving. Then, the first support member 100 and the second support member 200 rotate to terminal positions to be folded, as shown in FIG. 14. The folded adapter device 1 is shown in FIGS. 2 and 4. Understandably, when the second support member 200 receives force, the first support member 100 and the second support member 200 can also pivot with respect to each other.

As shown in FIGS. 5 to 8 and 15 to 17, in this embodiment, the second joint 320 has a lock hole 322, the first joint 310 has a through hole 313 corresponding to the lock hole 322, and the lock pin 350 is slidably connected in the through hole 313. An end of the lock pin 350 protrudes from the first joint 310 to connect the unlock operating member 360. The unlock operating member 360 can drive the lock pin 350 to slide within the through hole 313, such that another end of the lock pin 350 is detachably engaged in the lock hole 322. Needless to say, the lock hole may be formed on the first joint 310 and the unlock operating member 360 may be disposed on the second joint 320 or other positions and connected to the lock pin 350. By this way, the lock pin 350 can also be driven to slide and detachably engaged in the lock hole.

As shown in FIGS. 6, 8 and 15, the second joint 320 further has a restraining groove 323. The restraining groove 323 is arc-shaped and arranged concentrically with a pivot axis (i.e., the connecting shaft 331) of the first joint 310 and the second joint 320. The lock hole 322 is located at an end of the restraining groove 323. By this way, when the first joint 310 and the second joint 320 pivot with respect to each other, the lock pin 350 is engaged in the restraining groove 323 and slides along the restraining groove 323.

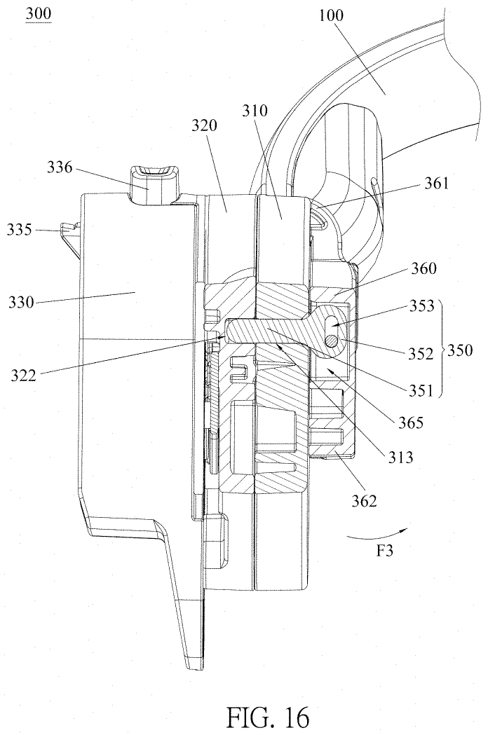

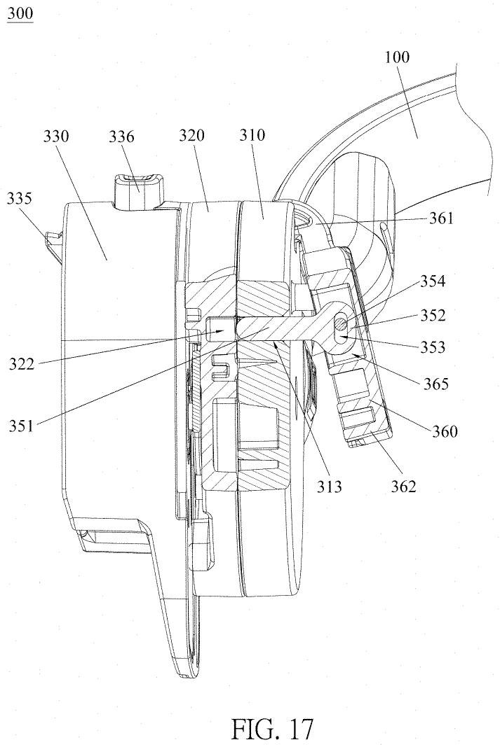

As shown in FIGS. 16 and 17, the lock pin 350 may include a lock rod 351 and a connecting head 352 disposed at an end of the lock rod 351. The connecting head 352 is formed as a sheet structure and has a longitudinal hole 353. An axial member 354 is disposed in the longitudinal hole 353 and pivotally connected to the unlock operating member 360. When the unlock operating member 360 rotates, the unlock operating member 360 drives the lock pin 350 to slide, such that another end of the lock rod 351 away from the connecting head 352 is detachably engaged with the lock hole 322.

As shown in FIGS. 1, 2, 5 to 7 and 15 to 17, the unlock operating member 360 includes a pivot portion 361 and an operating portion 362. The pivot portion 361 is pivotally connected to the first joint 310 by a shaft 3611 (as shown in FIG. 5). An axial direction of the shaft 3611 is perpendicular to an axial direction of the pivot axis of the first joint 310. When the operating portion 362 receives force, the unlock operating member 360 pivots on the shaft 3611 to drive the lock pin 350 to slide and unlock. The return member 370 abuts against the unlock operating member 360. When the unlock operating member 360 pivots, the return member 370 deforms. When the return member 370 recovers, the return member 370 drives the unlock operating member 360 to return.

In this embodiment, the pivot portion 361 protrudes from an end of the unlock operating member 360. The pivot portion 361 is pivotally connected in a recess 314 (as shown in FIGS. 5 to 7) at an edge of the first joint 310 by the shaft 3611. Another end of the unlock operating member 360 forms the operating portion 362. The return member 370 is disposed between the pivot portion 361 and the operating portion 362 by the fixing member 371. Specifically, the unlock operating member 360 has a longitudinal hole 363. The longitudinal hole 363 extends along a direction from the pivot portion 361 to the operating portion 362. A first abutting portion 364 protrudes from an inner wall towards a center of the longitudinal hole 363, as shown in FIG. 6. Furthermore, an end of the fixing member 371 has a second abutting portion 3711. The fixing member 371 is disposed in the longitudinal hole 363 and an end of the fixing member 371 is fixed to the first joint 310. The second abutting portion 3711 is located at the outside of the first joint 310 and apart from the first joint 310. The return member 370 is sleeved on the fixing member 371 and opposite ends of the return member 370 abut against the first abutting portion 364 and the second abutting portion 3711, as shown in FIGS. 1, 2, 5 and 6. When the operating portion 362 is pulled to drive the unlock operating member 360 to pivot on the shaft 3611 (i.e., the unlock operating member 360 rotates along a direction indicated by an arrow F3 shown in FIGS. 1 and 16), the first abutting portion 364 compresses the return member 370, such that the return member 370 deforms. After the operating portion 362 is released, the return member 370 recovers to drive the unlock operating member 360 to return (i.e., the unlock operating member 360 rotates along a reversed direction of the arrow F3 from the state shown in FIG. 17 to the state shown in FIG. 16), so as to drive the lock pin 350 to be engaged in the lock hole 322 or the restraining groove 323.

As shown in FIGS. 1, 5 and 6, the operating portion 362 has a through hole 3621. The pulling member 400 may be connected by the through hole 3621, such that the connection is more convenient.

As shown in FIGS. 5, 7, 16 and 17, the inside of the unlock operating member 360 further has an engaging groove 365 (as shown in FIG. 7) and an extending direction of the engaging groove 365 is substantially identical to an extending direction of the longitudinal hole 363. The connecting head 352 of the lock pin 350 is engaged in the engaging groove 365. The axial member 354 is disposed in the longitudinal hole 353 of the connecting head 352 and connected to a side wall of the engaging groove 365 (as shown in FIGS. 16 and 17). When the unlock operating member 360 rotates along the direction indicated by the arrow F3 shown in FIG. 16 or along the reversed direction of the arrow F3, the lock pin 350 is driven to slide by an interaction between the axial member 354 and the longitudinal hole 353.

Needless to say, the unlock operating member 360 and the return member 370 are not limited to the arrangement of this embodiment and may be achieved by other structures depicted in the following.

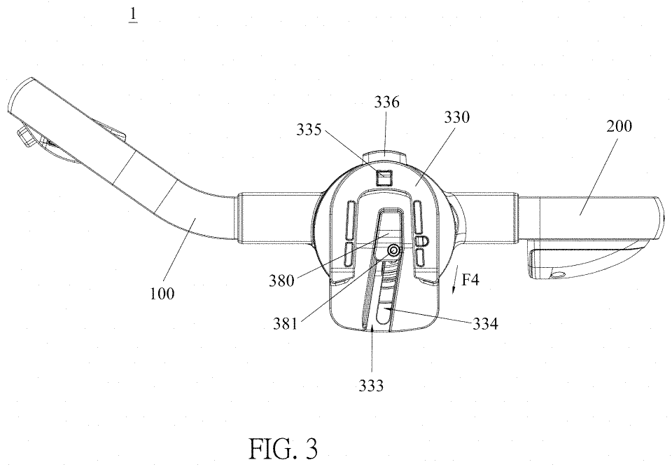

As shown in FIGS. 3, 4, 7, 8, and 10 to 14, the connecting mechanism 300 further includes a sliding block 380 and a linking rod 390. The sliding block 380 is slidably connected to the stationary base 330 and located at a side away from the second joint 320. The linking rod 390 is curved and disposed between the stationary base 330 and the second joint 320. An end of the linking rod 390 is connected to the sliding block 380 and another end of the linking rod 390 is pivotally connected to the second joint 320. When the second joint 320 pivots, the linking rod 390 drives the sliding block 380 to slide back and forth.

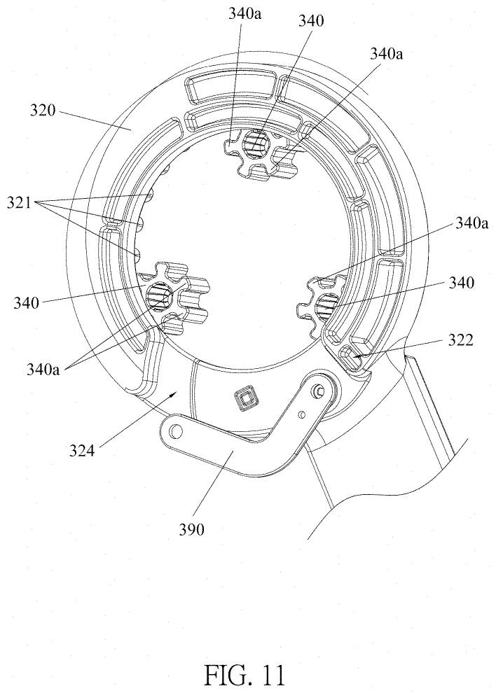

As shown in FIGS. 3, 4 and 7, the stationary base 330 has a sliding groove 333 for installing the sliding block 380. The sliding groove 333 extends along a direction from top to bottom of the stationary base 330. The sliding groove 333 further has a longitudinal hole 334 formed therein. An axial member 381 disposed in the longitudinal hole 334 connects the sliding block 380 and an end of the linking rod 390. Furthermore, as shown in FIG. 11, a breach 324 is formed at a side wall of the second joint 320. Another end of the linking rod 390 is pivotally connected in the breach 324. The breach 324 provides a space for the linking rod 390 to pivot.

As shown in FIGS. 3, 4, and 10 to 14, when the adapter device 1 is unfolded, the sliding block 380 is located at the top of the sliding groove 333 (as shown in FIG. 3). When the first joint 310 and the second joint 320 pivot and fold, the second joint 320 drives the linking rod 390 to move to drive the sliding block 380 to slide downward along the sliding groove 333 (i.e., slide along a direction indicated by an arrow F4 shown in FIG. 3). When the first joint 310 and the second joint 320 are folded completely, the sliding block 380 slides to the bottom of the sliding groove 333 (as shown in FIGS. 4 and 14). When the sliding block 380 slides downward, the sliding block 380 drives an unlock device disposed on the baby carriage to unlock, such that the adapter device 1 and the baby carriage are folded synchronously.

As shown in FIGS. 1 to 10, in this embodiment, the stationary base 330 may further have an engaging protrusion 335 for engaging with the baby carriage and a button 336 for driving the engaging protrusion 335 to protrude or retract. The structures and principles of the engaging protrusion 335 and the button 336 are well known by one of ordinary skill in the art, so the explanation will not be depicted herein.

When a bassinet needs to be connected to the adapter device 1, the adapter device 1 needs to be unfolded first. At this time, the first support 100 and the second support member 200 extend in opposite directions, as shown in FIGS. 1 and 3. The adapter device 1 may be placed on the ground or platform directly and then the bassinet may be engaged with the adapter device 1. The connection between the bassinet and the adapter device 1 is well known by one of ordinary skill in the art. The adapter device 1 can prevent the bassinet from shaking, such that a baby seated therein will feel more comfortable. Furthermore, the adapter device 1 may be engaged with a stroller, i.e., the stationary base 330 may be engaged with an engaging mechanism of the stroller, so as to install the bassinet on the stroller.

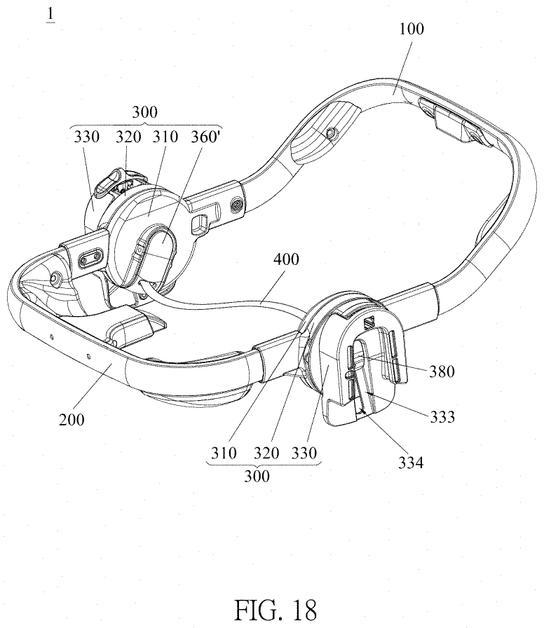

When the adapter device 1 does not need to be used, the bassinet, the adapter device 1 and the stroller may be detached from each other and then folded, or the adapter device 1 may be folded together with the stroller directly. Specifically, the pulling member 400 shown in FIGS. 1 and 18 may be pulled upward, such that the pulling member 400 pulls the unlock operating members 360 of the two connecting mechanisms 300 to pivot synchronously. The unlock operating member 360 drives the lock pin 350 to slide and disengage from the lock hole 322 of the second joint 320, as shown in FIG. 17. The return member 370 is compressed during the aforesaid process. Then, the first support member 100 is pushed to rotate over a specific angle and then the pulling member 400 is released. The unlock operating member 360 will return by the return member 370 and drive the lock pin 350 to slide towards the second joint 320, such that the lock pin 350 is engaged in the restraining groove 323, as shown in FIGS. 6 and 8.

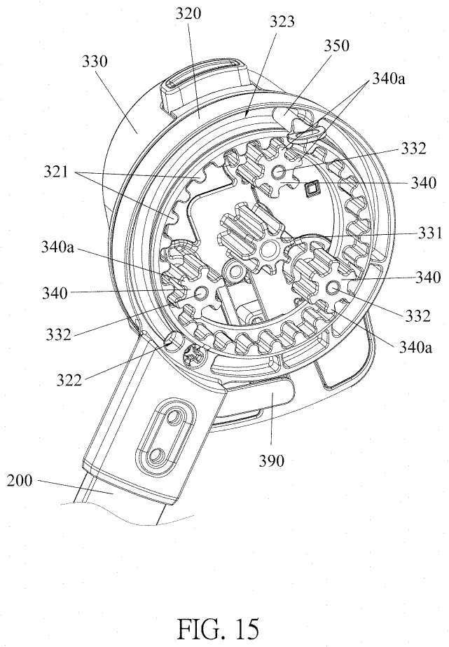

Then, the first support member 100 may be pushed to rotate along a direction indicated by an arrow F1 shown in FIG. 12. The first support member 100 drives the second support member 200 to rotate along a direction indicated by an arrow F2 shown in FIG. 12 until the first support member 100 and the second support member 200 pivot to a folding state shown in FIGS. 2, 4 and 14. During the aforesaid process, the lock pin 350 slides within the restraining groove 323, as shown in FIG. 15. The folding state of the adapter device 1 may be further referred to with respect to FIGS. 2 and 4.

Still further, when the first support member 100 and the second support member 200 pivot and fold, the second joint 320 drives the sliding block 380 to slide downward along the stationary base 330 by the linking rod 390. Accordingly, the sliding block 380 can drive the engaging mechanism of the stroller to unlock, such that the adapter device 1 can be folded together with the stroller, i.e., the adapter device 1 does not need to be detached from the stroller. The folding operation is simpler than other approaches.

As shown in FIGS. 18 to 22, in a second embodiment of the invention, the difference between the adapter device 1 and the aforesaid first embodiment is the arrangement of the unlock operating member 360′ and the return member 370′. Only the difference is depicted in the following and other similarities will not be depicted again.

Specifically, in this embodiment, the pivot portion 361′ is substantially formed at a middle portion of the unlock operating member 360′ and pivotally connected to the first joint 310 by the shaft 3611′. After the pivotal connection, an axial direction of the shaft 3611′ is perpendicular to an axial direction of the pivot axis of the first joint 310. The operating portion 362′ is formed at the lower end of the unlock operating member 360′. The return member 370′ abuts against an upper end of the unlock operating member 360′ and the first joint 310.

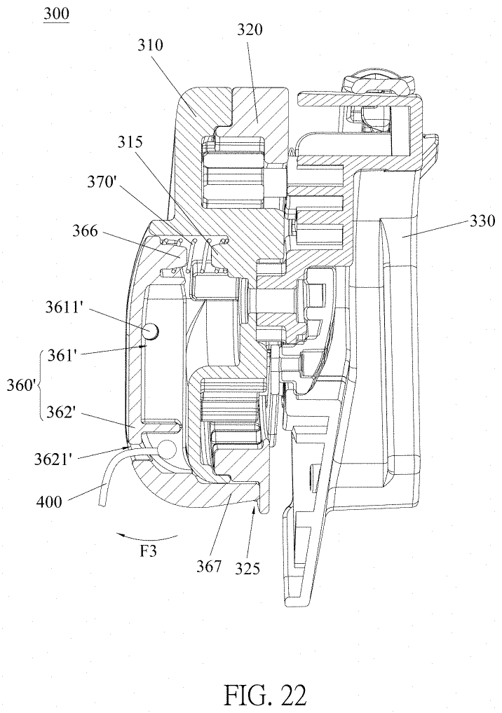

As shown in FIG. 22, the upper end of the unlock operating member 360′ has a first protruding pillar 366 protruding from a side and the first joint 310 has a second protruding pillar 315 corresponding to the first protruding pillar 366. Opposite ends of the return member 370′ are sleeved on the first protruding pillar 366 and the second protruding pillar 315, respectively, and abut against the unlock operating member 360′ and the first joint 310. Accordingly, when the operating portion 362′ is pulled to move away from the first joint 310, the unlock operating member 360′ pivots on the shaft 3611′ (i.e., the unlock operating member 360′ pivots on the shaft 3611′ along the direction indicated by the arrow F3 shown in FIG. 22) and the upper end of the unlock operating member 360′ moves close to the first joint 310 to compress and deform the return member 370′. When the operating portion 362′ is released, the return member 370′ recovers to drive the unlock operating member 360′ to return (i.e., drive the unlock operating member 360′ to return along a reversed direction of the arrow F3 shown in FIG. 22).

In this embodiment, the operations and principles for folding and unfolding the adapter device 1 are similar with the aforesaid embodiment, such that the duplicated explanation is omitted herein.

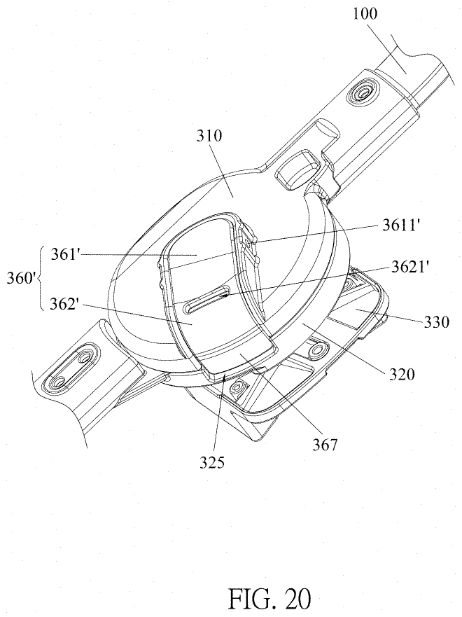

As shown in FIGS. 20 and 22, in this embodiment, the first joint 310 and the second joint 320 are not limited to be locked by the lock pin and may be locked by other manners. For example, the unlock operating member 360′ may be engaged with the second joint 320 directly. Specifically, the operating portion 362′ of the unlock operating member 360′ is bent and extends towards the second joint 320, so as to form an engaging portion 367 (as shown in FIGS. 20 and 22). A lock breach 325 (as shown in FIGS. 20 and 22) is formed at the edges of the second joint 320 and the first joint 310 and corresponds to the engaging portion 367. When the unlock operating member 360′ is located at an initial position, the engaging portion 367 crosses an outer edge of the first joint 310 and engages with the lock breach 325 on the second joint 320 (as shown in FIGS. 20 and 22). At this time, the first joint 310 and the second joint 320 cannot rotate with respect to each other. When the operating portion 362′ is pulled to drive the unlock operating member 360′ to pivot, the engaging portion 367 disengages from the lock breach 325. Meanwhile, the first joint 310 and the second joint 320 can rotate with respect to each other.

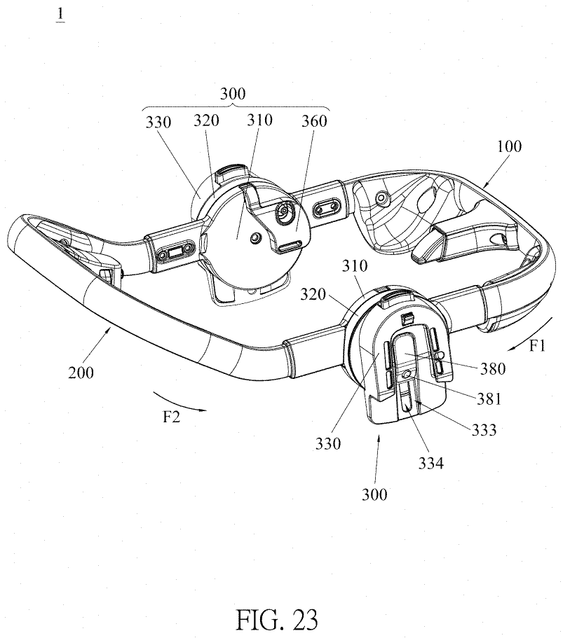

As shown in FIGS. 23 to 29, in a third embodiment of the invention, the difference between the adapter device 1 and the aforesaid first embodiment is the structure of the linking member 340 and the linking manner between the first joint 310 and the second joint 320. Only the difference is depicted in the following and other similarities will not be depicted again.

In this embodiment, the linking member 340 includes a first linking rod 341 and a second linking rod 342, wherein a first end 3411 of the first linking rod 341 is pivotally connected to the first joint 310 to form a first pivot point P1, a first end 3421 of the second linking rod 342 is pivotally connected to the second joint 320 to form a second pivot point P2, and a second end 3412 of the first linking rod 341 is pivotally connected to a second end 3422 of the second linking rod 342 to form a third pivot point P3. Furthermore, the center of the pivot axis of the first joint 310 and the second joint 320 forms a fourth pivot point P4 and the fourth pivot point P4 is located above the third pivot point P3. The first pivot point P1, the third pivot point P3, the second pivot point P2 and the fourth pivot point P4 are connected in sequence to form a four-bar linkage mechanism. When one of the first joint 310 and the second joint 320 receives force, the four pivot points of the aforesaid four-bar linkage mechanism pivot with respect to each other through an interaction between the first linking rod 341 and the second linking rod 342, so as to pull the other one of the first joint 310 and the second joint 320 to pivot. Accordingly, the first joint 310 and the second joint 320 can be folded automatically and the folding operation is simpler and more labor-saving.

As shown in FIGS. 23 to 27, in this embodiment, the first linking rod 341 and the second linking rod 342 are disposed between the second joint 320 and the stationary base 330.

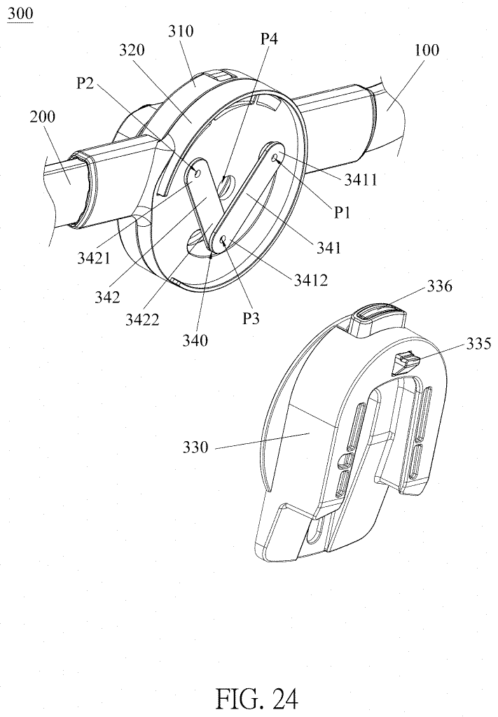

Specifically, a sliding hole 326 is formed on and through the second joint 320. The sliding hole 326 is arc-shaped and arranged concentrically with the pivot axis of the first joint 310 and the second joint 320 (i.e., the sliding hole 326 is centered on the fourth pivot point P4). At the same time, a pillar 316 is disposed on and protruded from the first joint 310. The pillar 316 is slidably disposed in the sliding hole 326. The pillar 316 extends toward the stationary base 330. The pillar 316 is pivotally connected to the first end 3411 of the first linking rod 341, as shown in FIG. 24.

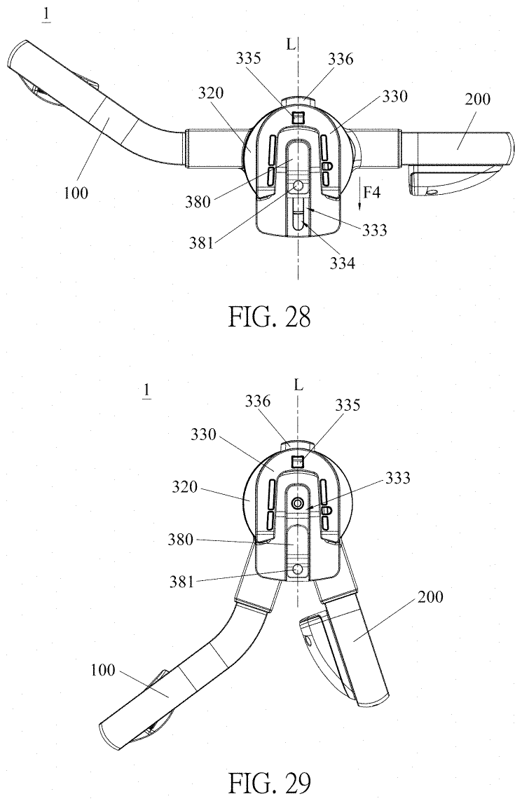

As shown in FIG. 23, the second end 3412 of the first linking rod 341 is pivotally connected to the second end 3422 of the second linking rod 342 by the axial member 381. The axial member 381 is slidably disposed in the longitudinal hole 334 of the stationary base 330 and connected to the sliding block 380. Thus, when the first joint 310 and the second joint 320 pivot to move close to each other, the first joint 310 and the second joint 320 drive the axial member 381 to slide downward along the longitudinal hole 334, so as to drive the sliding block 380 to slide downward along the sliding groove 333 as well, as shown in FIGS. 28 and 29. Accordingly, in this embodiment, the four-bar linkage mechanism achieves the linkage when the first joint 310 and the second joint 320 are folded and further drives the sliding block 380 to slide downward synchronously, thereby greatly simplifying the linkage structure between the first joint 310 and the second joint 320.

In this embodiment, the sliding groove 333 of the stationary base 330 extends upright along a central axial line L of the stationary base 330 and the longitudinal hole 334 in the sliding groove 333 also extends upright along the central axial line L.

It should be noted that the parts not described in detail in this embodiment are the same as those in the aforesaid first embodiment.

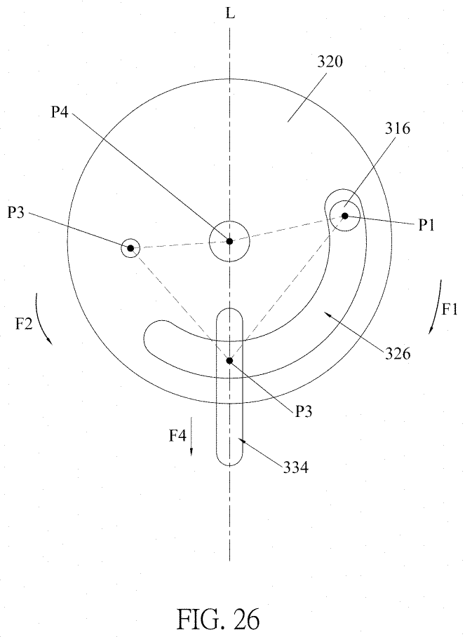

Referring to FIGS. 23 to 29 again, the pivoting and folding operation of the adapter device 1 in this embodiment will be described. As shown in FIGS. 23 and 28, when the adapter device 1 is unfolded, the sliding block 380 is located at the top of the sliding groove 333. At this time, the first linking rod 341 and the second linking rod 342 are located at the positions shown in FIG. 26. When the unlock operating member 360 is pulled to be unlocked, the first support member 100 and the second support member 200 can be pushed to pivot and fold. The specific operation is described in the following.

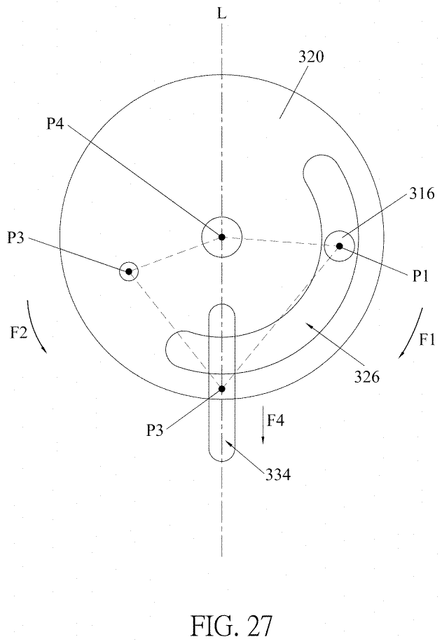

If the first support member 100 is pushed to rotate along a direction indicated by an arrow F1 shown in FIG. 23, the first support member 100 drives the first joint 310 to rotate synchronously. During the rotation of the first joint 310, the pillar 316 of the first joint 310 will slide within the sliding hole 326 of the second joint 320, as shown in FIG. 27. The pillar 316 drives the first end 3411 of the first linking rod 341 to slide along the sliding hole 326 (i.e., the first end 3411 of the first linking rod 341 rotates around the fourth pivot point P4), such that the position of the first end 3411 of the first linking rod 341 will lower, as shown in FIG. 27. During the movement of the first linking rod 341, its second end 3412 will move downward, thereby pushing the axial member 381 connected to the second end 3412 to slide downward along the longitudinal hole 334 of the stationary base 330 (i.e., move downward along the direction indicated by the arrow F4 shown in FIGS. 26 and 27), as shown in FIG. 27.

When the position of the first linking rod 341 is moving downward, the first linking rod 341 pulls the second end 3422 of the second linking rod 342 to move downward along the longitudinal hole 334 (i.e., move downward along the direction indicated by the arrow F4), such that the angle included between the second end 3412 of the first linking rod 341 and the second end 3422 of the second linking rod 342 changes. Then, the first end 3421 of the second linking rod 342 rotates around the second pivot point P2 and pulls the second joint 320 to move downward, such that the second joint 320 rotates along the direction indicated by the arrow F2 shown in FIGS. 26 and 27 (i.e., the rotating direction of the second joint 320 is opposite to the rotating direction of the first joint 310). During the aforesaid process, the first to four pivot points P1-P4 of the four-bar linkage mechanism rotate with respect to each other, as shown in FIG. 27. Accordingly, the user may push the first support member 100 to pivot by one hand, so as to drive the second support member 200 to rotate reversely to move close to the first support member 100 (as shown in FIG. 29), such that the folding operation is simpler and more labor-saving.

Furthermore, when the first joint 310 and the second joint 320 pivot to move close to each other, the first joint 310 and the second joint 320 drive the sliding block 380 to slide downward along the sliding groove 333. When the first joint 310 and the second joint 320 are folded completely, the sliding block 380 slides to the bottom of the sliding groove 333 (as shown in FIG. 29). When the sliding block 380 slides downward, the sliding block 380 may drive an unlock device disposed on a baby carriage to unlock, such that the adapter device 1 and the baby carriage may be folded synchronously.

Understandably, when the second support member 200 receives force, the first support member 100 and the second support member 200 can also pivot with respect to each other to be folded.

As mentioned in the above, the connecting mechanism 300 of the invention has the first joint 310, the second joint 320 and the lock pin 350, wherein the first joint 310 and the second joint 320 are pivotally connected to each other, and the lock pin 350 is connected between the first joint 310 and the second joint 320. The unlock operating member 360, 360′ can unlock the connecting mechanism 300 conveniently to achieve pivotal operations for folding and unfolding and the operations are simple and labor-saving. Furthermore, one of the first joint 310 and the second joint 320 is connected to the stationary base 330. The stationary base 330 is configured to be detachably connected to the baby carriage. Accordingly, the connecting mechanism 300 can be installed on different baby carriages according to different requirements. When the connecting mechanism 300 is applied to the adapter device 1, the adapter device 1 can be convenient and labor-saving enough for folding and unfolding, such that the operations are more convenient and the folded adapter device 1 occupies less storage space. Since the stationary base 330 can be connected to different baby carriages, a baby containing device can be installed on different baby carriages by the adapter device 1, such that the baby containing device can be used more flexible and convenient.

The structures of the baby containing device and the baby carriage involved in the invention are well known by one skilled in the art, so the explanation will not be depicted herein.

Those skilled in the art will readily observe that numerous modifications and alterations of the device and method may be made while retaining the teachings of the invention. Accordingly, the above disclosure should be construed as limited only by the metes and bounds of the appended claims.

1. A connecting mechanism comprising:
a first joint;
a second joint pivotally connected to the first joint;
a lock pin movably disposed between the first joint and the second joint and configured to lock or unlock the first joint and the second joint;
an unlock operating member connected to the lock pin and configured to drive the lock pin to disengage from the first joint or/and the second joint, so as to unlock the first joint and the second joint; and
a stationary base connected to the first joint or the second joint and configured to be detachably connected to a baby carriage.

2. The connecting mechanism of claim 1, wherein the connecting mechanism further comprises a linking member connected to the first joint and the second joint; when one of the first joint and the second joint receives force, the other one of the first joint and the second joint is driven to pivot by the linking member.

3. The connecting mechanism of claim 2, wherein the linking member is pivotally connected between the first joint and the second joint and has a plurality of protruding teeth, the first joint has a plurality of first gear teeth meshing with the protruding teeth, the second joint has a plurality of second gear teeth meshing with the protruding teeth, and the first joint and the second joint pivot with respect to each other by an interaction between the first gear teeth, the protruding teeth and the second gear teeth.

4. The connecting mechanism of claim 3, wherein a connecting base is disposed at and protruded from one side of the first joint, the first gear teeth are disposed at an outer wall of the connecting base, the second joint is circular, and the second gear teeth are disposed at an inner wall of the second joint.

5. The connecting mechanism of claim 3, wherein the connecting mechanism comprises a plurality of linking members evenly arranged around a pivot axis of the first joint and the second joint.

6. The connecting mechanism of claim 1, wherein one of the first joint and the second joint has a lock hole, and the lock pin is slidably connected to the other one of the first joint and the second joint and detachably engaged in the lock hole.

7. The connecting mechanism of claim 6, wherein one of the first joint and the second joint with the lock hole further has a restraining groove; when the first joint and the second joint pivot with respect to each other, the lock pin slides within the restraining groove.

8. The connecting mechanism of claim 7, wherein the restraining groove is arc-shaped and arranged concentrically with a pivot axis of the first joint and the second joint.

9. The connecting mechanism of claim 6, wherein the lock pin comprises a lock rod and a connecting head disposed at an end of the lock rod, the connecting head is pivotally connected to the unlock operating member, and another end of the lock rod away from the connecting head is detachably engaged with the lock hole.

10. The connecting mechanism of claim 1, wherein the unlock operating member comprises a pivot portion and an operating portion, and the pivot portion is pivotally connected to the first joint or the second joint; when the operating portion receives force, the unlock operating member pivots to drive the lock pin to slide and unlock.

11. The connecting mechanism of claim 10, wherein the connecting mechanism further comprises a return member, and the return member abuts against the unlock operating member and has a tendency to return the unlock operating member to an initial position.

12. The connecting mechanism of claim 10, wherein the connecting mechanism further comprises a fixing member, the fixing member is disposed on and through the unlock operating member and fixed to the first joint or the second joint, and the return member abuts against the unlock operating member and the fixing member; when the unlock operating member receives force, the return member deforms.

13. The connecting mechanism of claim 12, wherein the unlock operating member has a longitudinal hole, a first abutting portion protrudes from an inner wall towards a center of the longitudinal hole, the fixing member is disposed in and through the longitudinal hole, an end of the fixing member away from the first joint or the second joint has a second abutting portion, and the return member abuts against the first abutting portion and the second abutting portion.

14. The connecting mechanism of claim 11, wherein an end of the unlock operating member has a first protruding pillar, the first joint or the second joint has a second protruding pillar corresponding to the first protruding pillar, and opposite ends of the return member are sleeved on the first protruding pillar and the second protruding pillar, respectively.

15. The connecting mechanism of claim 10, wherein the unlock operating member has a through hole for receiving a pulling member.

16. The connecting mechanism of claim 1, wherein a connecting shaft is protruded from and configured on the stationary base, one of the first joint and the second joint is pivotally connected to the connecting shaft, and the other one of the first joint and the second joint is sandwiched in between the other two.

17. The connecting mechanism of claim 16, wherein the connecting mechanism further comprises a sliding block, and the sliding block is slidably connected to the stationary base and pivotally connected to the first joint or the second joint; when the first joint and the second joint pivot with respect to each other, the sliding block is driven to slide.

18. The connecting mechanism of claim 17, wherein the connecting mechanism further comprises a linking rod, an end of the linking rod is connected to the sliding block, and another end of the linking rod is pivotally connected to the first joint or the second joint; when the first joint and the second joint pivot with respect to each other, the linking rod drives the sliding block to slide.

19. The connecting mechanism of claim 17, wherein the stationary base has a sliding groove, the sliding block is slidably connected in the sliding groove and located at a side of the stationary base away from the first joint or the second joint.

20. The connecting mechanism of claim 2, wherein the linking member comprises a first linking rod and a second linking rod, the first linking rod is pivotally connected to the second linking rod, the first linking rod and the second linking rod are pivotally connected to the first joint and the second joint, respectively; when the first linking rod and the second linking rod pivot with respect to each other, the first linking rod and the second linking rod drive the first joint and the second joint to pivot with respect to each other.

21. The connecting mechanism of claim 20, wherein a pillar is disposed on and protruded from the first joint, the pillar is slidably disposed through the second joint and pivotally connected to a first end of the first linking rod, a first end of the second linking rod is pivotally connected to the second joint, a second end of the first linking rod is pivotally connected to a second end of the second linking rod by an axial member, and the axial member is slidably connected to the stationary base.

22. The connecting mechanism of claim 21, wherein a sliding hole is formed on and through the second joint, the sliding hole is arc-shaped and arranged concentrically with a pivot axis of the first joint and the second joint, and the pillar is slidably disposed in the sliding hole.

23. The connecting mechanism of claim 21, wherein the connecting mechanism further comprises a sliding block, the sliding block is slidably connected to the stationary base and pivotally connected to the axial member; when the first joint and the second joint pivot with respect to each other, the first joint and the second joint drive the sliding block to slide through the axial member.

24. An adapter device comprising a first support member, a second support member and the connecting mechanism of claim 1, the first support member being connected to one of the first joint and the second joint, the second support member being connected to the other one of the first joint and the second joint.

25. The adapter device of claim 24, wherein the first support member and the second support member are substantially U-shaped, the first support member and the second support member are connected to each other by two connecting mechanisms, and the unlock operating members of the two connecting mechanisms are connected to each other by a pulling member.
